(19) United States
(12) Patent Application Publication
(10) Pub. No.: US 2004/0162903 A1
(43) Pub. Date: Aug. 19, 2004

(54) Apparatus and method for automatically logging in internet web site

(75) Inventor: Jong Sang Oh, Gyeonggi-Do (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics Inc.

(21) Appl. No.: 10/746,732

(22) Filed: Dec. 23, 2003

(30) Foreign Application Priority Data
Dec. 28, 2002 (KR) 85814/2002

(51) Int. Cl. G06F 15/16

(52) U.S. Cl. 709/228; 709/229

(57) ABSTRACT

An apparatus and a method for automatically logging in an Internet Web site at a set top box are disclosed. The apparatus is for logging in an Internet Web site based on user information stored in a smart card.

### BACKGROUND OF THE INVENTION

1. Field of the Invention

The present invention relates to a set top box, and particularly, to an apparatus and a method for automatically logging in Internet Web site.

2. Description of the Background Art

In general, a set top box is that a broadcast and computer communication are combined, and is an apparatus capable of functioning as a multimedia which presents image, voice, picture graphic, and the like. As high-speed Internet is diffused recently, set top box products only for Internet are developed and being diffused to each home. Among such set top boxes, the most representative one is an Internet TV.

The Internet TV is provided with a PSTN (Public Switched Telephone Network) modem or an xDSL (x Digital Subscriber Line) modem, both which make Internet connection possible, a mouse and a keyboard which are means for input, a TV which substitutes for a monitor of a computer, a CPU (Central Processing Unit) which can control various devices, and also a hard disk which makes downloading and storing various data possible.

However, a method for logging in an Internet Web site according to the conventional art is disadvantageous in that every time a user tries to log in an Internet Web site, a user has to personally input information of an Internet Web site, and a user ID (Identification Number) and a password.

In addition, a method for logging in an Internet Web site according to the conventional art is disadvantageous in that a user has to memorize all user IDs and passwords for logging in a plurality of Internet Web sites.

### SUMMARY OF THE INVENTION

Therefore, an object of the present invention is to provide an apparatus and a method for automatically logging in an Internet Web site capable of automatically logging in an Internet Web site by connecting with the Internet Web site through a smart card in which user ID and password information for logging in the Internet Web site are stored.

Another object of the present invention is to provide an apparatus and a method for automatically logging in an Internet Web site, by which a user does not need to memorize a large number of user IDs and passwords for logging in a plurality of Internet Web sites by connecting with the Internet Web site through a smart card in which user ID and password information for logging in the Internet Web site are stored.

To achieve these and other advantages and in accordance with the purpose of the present invention, as embodied and broadly described herein, there is provided an apparatus for automatically logging in an Internet Web site according to the present invention for logging in an Internet Web site based on user information stored in a smart card.

To achieve these and other advantages and in accordance with the purpose of the present invention, as embodied and broadly described herein, there is provided a method for automatically logging in an Internet Web site according to the present invention comprising logging in an Internet Web site based on user information stored in a smart card.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a block diagram illustrating a structure of a set top box to which an apparatus for automatically logging in an Internet Web site is applied; and

FIG. 2 is a flow chart illustrating a method for automatically logging in an Internet Web site according to the present invention.

### DETAILED DESCRIPTION OF THE PREFERRED EMBODIMENTS

Reference will now be made in detail to the preferred embodiments of the present invention, examples of which are illustrated in the accompanying drawings.

Hereinafter, a preferred embodiment of an apparatus and a method for automatically logging in an Internet Web site capable of automatically logging in a corresponding Internet Web site by connecting to an Internet Web site through a smart card in which a user ID and a password for logging in an Internet Web site are stored, will now be described with reference to an accompanying drawings.

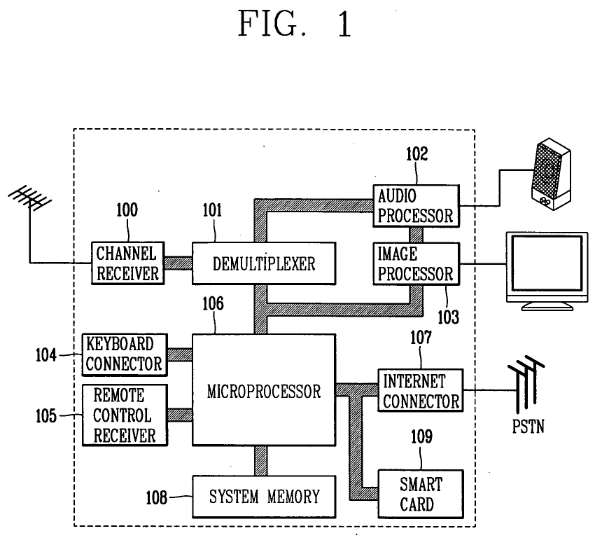

FIG. 1 is a block diagram illustrating a structure of a set top box to which an apparatus for automatically logging in an Internet Web site is applied.

As shown therein, a set top box to which the apparatus for automatically logging in an Internet Web site is applied, includes a channel receiver 100 for converting a broadcast signal received through an antenna into a digital signal; a demultiplexer 101 for demultiplexing the converted digital signal; an audio processor 102 for processing a demultiplexed audio signal; an image processor 103 for processing a demultiplexed image signal; a keyboard connector 104 for connecting a keyboard; a remote control receiver 105 for receiving a key-input signal of a remote control; a microprocessor 106 for operating an entire system; an Internet connector 107 for connecting with Internet through a modem; a system memory 108 for temporarily storing a system software for operating an entire system; and a smart card 109 in which predetermined user information is stored.

A process of operating the set top box to which an apparatus for automatically logging in an Internet Web site is applied, constructed as above will now be described in detail.

First, the channel receiver 100 receives a broadcast signal, and demodulates the received broadcast signal. And, the channel receiver 100 digitalizes the demodulated broadcast signal, and outputs the digitalized broadcast signal to the demultiplexer 101. At this time, the inputted digitalized broadcast signal is a compressed transport stream, and a signal in which an audio, a video and supplementary data (e.g., program guide information or the like) are multiplexed.

The demultiplexer 101 demultiplexes the multiplexed audio, the video and the supplementary data according to each SCID (Subscriber Channel Identification). Then, the demultiplexer 101 outputs the demultiplexed video signal to the image processor 103, and outputs the demultiplexed audio signal to the audio processor 102.

The image processor 103 restores the inputted video signal in a state prior to compression thereof by decoding the inputted video signal. That is, if the inputted video signal has been compressed by a method of MPEG 2 (Motion Picture Experts Group-2), the inputted video signal is restored through the MPEG-2 decoding algorithm. And, the image processor 103 converts the restored video signal into a video signal corresponding to a corresponding display apparatus based on OSD (On Screen Display) data inputted by a user, and outputs the converted video signal to a display apparatus having a resolution of HD (High Definition) or SD (Standard Definition).

The audio processor 102 restores the audio signal inputted from the demultiplexer 101 through a decoding algorithm, and outputs the restored audio signal to an external speaker so that its display time is the same as that of the restored video signal.

At this time, the microprocessor 106 transmits/receives control data for controlling an entire system to/from various devices, and the system memory 109 stores a system software for operating an entire system based on the control data of the microprocessor 106.

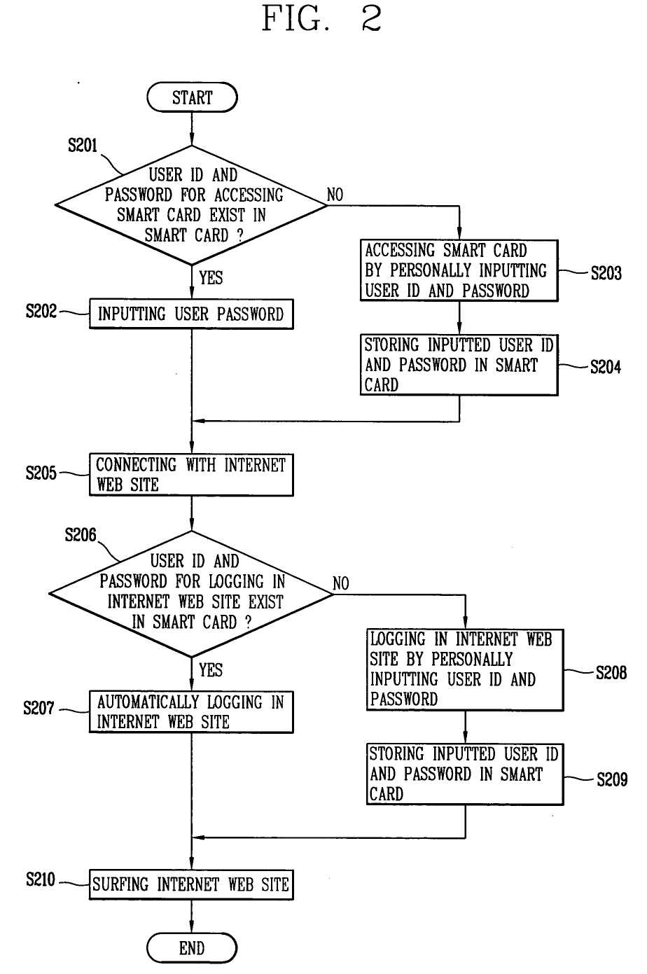

In addition, the set top box to which the apparatus for automatically logging in an Internet Web site is applied connects with Internet through the Internet connector 107 based on the control signal outputted from the microprocessor 106. Herein, the Internet connector 107 is provided with the PSTN modem or the xDSL modem so as to connect with the Internet. Hereinafter, a method for automatically logging in a corresponding Internet Web site when a user connects with a specific Internet Web site will now be described with reference to FIG. 2.

FIG. 2 is a flow chart illustrating a method for automatically logging in an Internet Web site according to the present invention.

As shown in FIG. 2, a method for automatically logging in an Internet Web site according to the present invention includes the steps of checking whether a user ID (Identification Number) and a password for accessing a smart card have been stored in the smart card (S201); personally inputting a user password if the user ID and password have been stored in the smart card (S202); connecting with a desirable Internet Web site (S205); checking whether a user ID and a password for logging in the connected Internet Web site exist in the inserted smart card (S206); automatically logging in the Internet Web site if the user ID and the password have been stored in the smart card (S207); and surfing the Internet Web site which the user has logged in (S210). Herein, if a user ID and a password for accessing the smart card do not exist in the smart card, the step that the a user personally inputs the user ID and the password (S203), and the step of storing the inputted user ID and the password in the smart card (S204) are performed. In addition, if a user ID and a password information for logging in the connected Internet Web site do not exist, the step of logging in the Internet Web site by personally inputting the user ID and the password (S208); and the step of storing the inputted user ID and password in the smart card (S209) are performed.

The method for automatically logging in an Internet Web site according to the present invention constructed as above will now be described in detail.

First, a system software stored in the system memory 108 checks whether a user ID and a password for accessing the smart card exist in the smart card (S201). If the user ID and the password exist in the smart card, the system software displays the user ID, and receives a user password from the user (S202). Herein, If a user ID and a password do not exist in the smart card, the system software requires user information for accessing the smart card to the user. That is, the system software receives a user name, a user ID and a password for accessing the smart card from the user, and accesses the smart card (S203). Then, the system software stores the inputted user information to an NVRAM (Nonvolatile Random Access Memory) installed inside the smart card (S204). Besides, the system software receives E-mail server information of a user, and a user ID and a password for logging in an E-mail server of the user from the user, also receives information of an Internet Web site which the user has subscribed, and a user ID and a password for logging in the Internet Web site, and store the received user information to the NVRAM.

The system software connects with Internet through the Internet connector based on a signal inputted to a remote control receiver 105 or a keyboard connector 104. Herein, the remote control receiver 105 receives key-input of a remote control which a user selects, and thus, through the remote control receiver 105, the user can surf Internet, select a menu, change a channel, control a sound volume of an audio, and the like. When the user surfs Internet, the keyboard connector 104 receives supplementary data such as a URL (Uniform Resource Locator) of an Internet Web site from the user.

Thereafter, the user connects with an Internet Web site through the keyboard or the remote control (S205). When the user connects with an Internet Web site, the system software checks whether a user ID and a password for logging in the Internet Web site have been stored in the smart card (S206). If the user ID and the password exist in the smart card, the system software automatically logs in the Internet Web site based on the ID and password information stored in the smart card (S207).

On the other hand, if the user ID and the password have not been stored in the smart card, the system software notifies the user. Herein, the connected Internet Web site may be a site that the user has not subscribed, or may be a site that a user has subscribed, but not stored. Accordingly, if the connected Internet Web site is that the user has not subscribed, the user subscribes to the Internet Web site and logs in the Internet Web site based on the subscription information (S208), and the system software automatically stores the Internet Web site information (e.g., a server address of corresponding Web site) and the inputted user ID and password in the smart card (S209).

In addition, if the connected Internet Web site is that the user has subscribed, but not stored in the smart card, the user personally inputs a user ID and a password through the keyboard and thus logs in the Internet Web site (S208), and the system software stores information of the Internet Web site and the inputted user ID and the password in the smart card (S209). So, when the user connects with the Internet Web site in the future, the system software can automatically log in the Internet Web site by such stored user information based on the stored user ID and the password.

Accordingly, the user can check an E-mail or surf Internet through the Internet Web site which has been logged in (S210).

However, the apparatus and the method for automatically logging in an Internet Web site can be implemented only when a user accesses the smart card. That is, if the user can not access the smart card, the system software can not automatically log in an Internet Web site stored in the smart card.

As so far described in detail, in the method for automatically logging in an Internet Web site according to the present invention, an Internet Web site is connected with through a smart card in which a user ID and a password for logging in the Internet Web site are stored, whereby the corresponding Internet Web site can be automatically logged in based on the stored user ID and the password.

In addition, in the method for automatically logging in an Internet Web site according to the present invention, an Internet Web site is connected with through a smart card in which a user ID and a password for logging in the Internet Web site are stored, whereby a user does not need to memorize all the user IDs and passwords for logging in a plurality of Internet Web sites.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for automatically logging in an Internet Web site, wherein the Internet Web site is logged in based on user information stored in a smart card.

2. The apparatus of claim 1, wherein the smart card stores a user ID and a password for accessing the smart card.

3. The apparatus of claim 2, wherein the smart card stores information of an Internet Web site, and a user ID and a password, for logging in an Internet Web site.

4. The apparatus of claim 1, wherein the smart card is connected with a smart card holder installed at a set top box.

5. The apparatus of claim 1, wherein the user information is stored in an NVRAM (Nonvolatile Random Access Memory) installed inside the smart card.

6. A method for automatically logging in an Internet Web site comprising logging in an Internet Web site based on user information stored in a smart card.

7. The method of claim 6, wherein the smart card stores a user ID (Identification Number) and a password for accessing the smart card.

8. The method of claim 6, wherein the smart card stores information of an Internet Web site, and a user ID and a password, for logging in the Internet Web site.

9. The method of claim 6, wherein the smart card is connected with a smart card holder installed at a set top box.

10. The method of claim 6, wherein the user information is stored in an NVRAM (Nonvolatile Random Access Memory) installed inside the smart card.

11. A method for automatically logging in an Internet Web site comprising:
checking a user ID and a password for accessing a smart card;
connecting with an Internet Web site when the smart card is accessed based on the user ID and the password;
checking an user ID and a password previously stored in the smart card in order to log in the connected Internet Web site; and
if the user ID and the password have been previously stored in the smart card, automatically logging in an Internet Web site based on the previously stored user ID and password.

12. The method of claim 11, wherein a user can access the smart card when a user ID and a password for accessing the smart card are the same as a user ID and a password which are inputted by the user.

13. The method of claim 11, wherein a user cannot access the smart card if a user ID and a password for accessing the smart card are not the same as a user ID and a password which are inputted by the user.

14. The method of claim 11, wherein the smart card stores information of an Internet Web site, and a user ID and a password, for logging in an Internet Web site.

15. The method of claim 11, wherein the smart card is connected with a smart card holder installed at a set top box.

16. The method of claim 11, wherein the user information is stored in an NVRAM (Nonvolatile Random Access Memory) installed inside the smart card.

17. The method of claim 11, wherein, if a user ID and a password for logging in the connected Internet Web site have not been stored in the smart card, a user personally inputs the user ID and the password.

18. The method of claim 17, wherein the smart card stores the inputted user ID and the password in the smart card.
